(19) United States
(12) Patent Application Publication
(10) Pub. No.: US 2024/0083724 A1
(43) Pub. Date: Mar. 14, 2024

(54) MOBILE ALIGNMENT SYSTEM

(71) Applicant: Rivian IP Holdings, LLC, Plymouth, MI (US)

(72) Inventor: Philip Samuel Tompkins, Irvine, CA (US)

(21) Appl. No.: 17/931,648

(22) Filed: Sep. 13, 2022

(51) Int. Cl. B66F 7/28; B60L 53/80

(52) U.S. Cl. CPC B66F 7/28; B60L 53/80

(57) ABSTRACT

A system can include a plate. The system can include a lift assembly. The lift assembly can include a member. The member can couple with the plate. The lift assembly can include a column. The column can define a channel. The channel can receive the member. The member can move along the channel.

### INTRODUCTION

Vehicles can benefit from drive train alignment. The distance a vehicle can travel can depend on characteristics of the drive train alignment.

### SUMMARY

The present disclosure is directed towards providing a system, such as a vehicle lift apparatus, that can lift a vehicle. The system can include a plate. The plate can include a ramp and a movable disk. The plate can receive a vehicle tire of the vehicle. The system can include a lift assembly. The lift assembly can engage with a bottom portion of the plate and raise the plate such that the lift assembly lifts the vehicle tire and the vehicle from a first position to a second position. For example, the lift assembly can lift the vehicle tire between 4 inches feet and 5 feet above (in an operational orientation of the apparatus) the first position. The system can be portable. For example, the apparatus can be stored at a first location and assembled at a second location. For example, the apparatus can be stored in a service vehicle, e.g., a van, and assembled at a location of a vehicle to be serviced. Additionally, the apparatus does not have to be stored and assembled in different locations. For example, the apparatus can be stored the service vehicle and assembled in the field, from the service vehicle. For example, the apparatus can lift the vehicle within the service vehicle. It can be a challenge to lift the vehicle such that all of the vehicle tires are level. As such, the lift assembly can be electronically powered and controlled so the tires of the vehicle are lifted simultaneously or incrementally, e.g., in increments of between 2 and 12 inches.

At least one aspect is directed to a system. The system can include a plate. The system can include a lift assembly. The lift assembly can include a member. The member can couple with the plate. The lift assembly can include a column. The column can define a channel. The channel can receive the member. The member can move along the channel.

At least one aspect is directed to a method. The method can include providing a plate. The method can include positioning a lift assembly adjacent to the plate. The lift assembly can include a member. The member can couple with the plate. The method can include moving the member along a channel defined in the column.

At least one aspect is directed to a method. The method can include providing a system. The system can include a plate. The plate can include a bottom portion. The system can include a lift assembly. The lift assembly can include a member. The member can couple with the bottom portion of the plate. The lift assembly can include a column. The column can define a channel. The channel can receive a portion of the member. The portion of the member can move along the channel. The portion of the member can raise the member and the plate from a first position coupled with the column to a second position coupled with the column.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a side view of a vehicle, according to an exemplary embodiment.

FIG. 2A depicts a perspective view of a battery pack, according to an exemplary embodiment.

FIG. 2B depicts a perspective view of a battery module, according to an exemplary embodiment.

FIG. 3 depicts a perspective view of a system, according to an exemplary embodiment.

FIG. 4 depicts a perspective view of a plate, according to an exemplary embodiment.

FIG. 5 depicts a perspective view of the system in a first position, according to an exemplary embodiment.

FIG. 6 depicts a perspective view of the system in a second position, according to an exemplary embodiment.

FIG. 7 depicts a flow diagram illustrating a method, according to an exemplary embodiment.

### DETAILED DESCRIPTION

Following below are more detailed descriptions of various concepts related to, and implementations of, methods, apparatuses, and systems of a mobile alignment system for a vehicle. The various concepts introduced above and discussed in greater detail below may be implemented in any of numerous ways.

The present disclosure is generally directed to a system such as a vehicle lift apparatus that can lift a vehicle. Systems of a vehicle can change with use such that optimum performance of the vehicle can be hindered. For example, the drive train of a vehicle can change or otherwise become misaligned with regular use of the vehicle when drive train components experience forces outside of threshold values. Such movement of the drive train can lead to changes to the systems within the vehicle, hindering the performance of the vehicle or the systems within the vehicle.

Systems and methods of the present technical solution can provide an apparatus that can lift a vehicle. The apparatus can include a plate. The plate can include a ramp and a movable disk. The plate can receive a vehicle tire of the vehicle. The apparatus can include a lift assembly. The lift assembly can engage with a bottom portion of the plate and raise the plate such that the lift assembly lifts the vehicle tire and the vehicle from a first position to a second position. For example, the lift assembly can lift the vehicle tire between 2 feet and 3 feet above (in an operational orientation of the apparatus) the first position.

The disclosed solutions have a technical advantage of optimizing assembly efficiency while increasing vehicle service efficiency. For example, the apparatus can be portable. The apparatus can be stored at a first location and assembled at a second location. For example, the apparatus can be stored in a service vehicle, e.g., a van, and the apparatus can be assembled at a location of a vehicle to be serviced. Additionally, the apparatus does not have to be stored and assembled in different locations. For example, the apparatus can be stored as well as assembled in the service vehicle. For example, the apparatus can lift the vehicle within the service vehicle. It can be a challenge to lift the vehicle such that all of the vehicle tires are level. As such, the lift assembly can be electronically powered and controlled so the tires of the vehicle are lifted simultaneously.

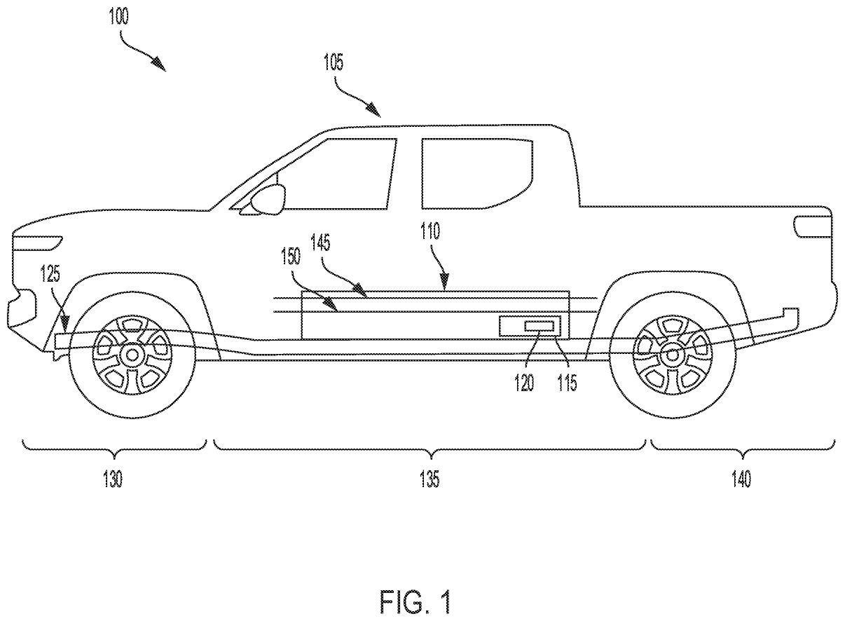

FIG. 1 depicts an example cross-sectional view 100 of a vehicle 105. The vehicle 105 can be an electric vehicle installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles 105. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

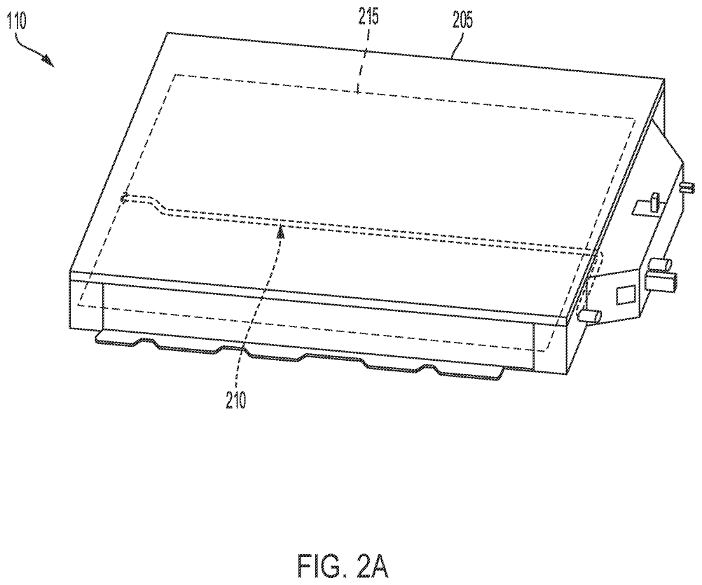

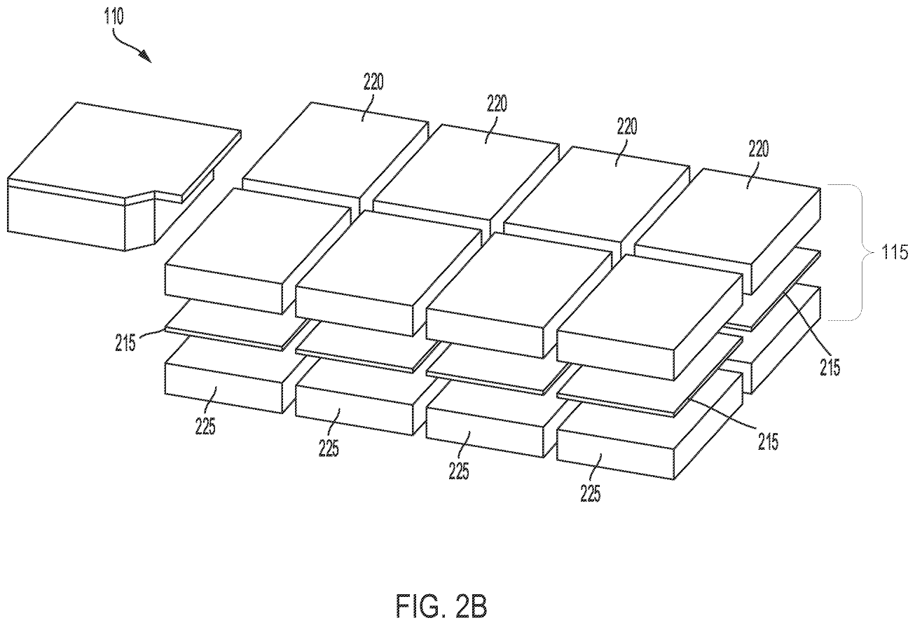

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.). The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery pack 110 can include any number of battery modules 115. For example, the battery pack can have one, two, three, four, five, six, seven, eight, nine, ten, eleven, twelve or other number of battery modules 115 disposed in the housing 205. The battery pack 110 can include or define a plurality of areas (e.g., compartments) for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

The battery modules 115 can each include a plurality of battery cells 120. The battery modules 115 can be disposed within the housing 205 of the battery pack 110. The battery modules 115 can include battery cells 120 that are cylindrical cells, pouch cells, or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. For example, the battery cell 120 can include a lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Yet further, some battery cells 120 can be solid state battery cells and other battery cells 120 can include liquid electrolytes for lithium-ion battery cells.

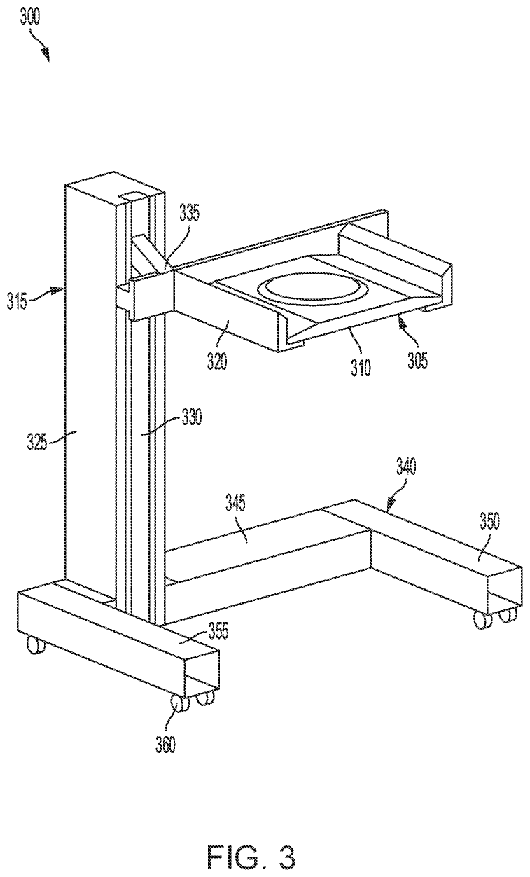

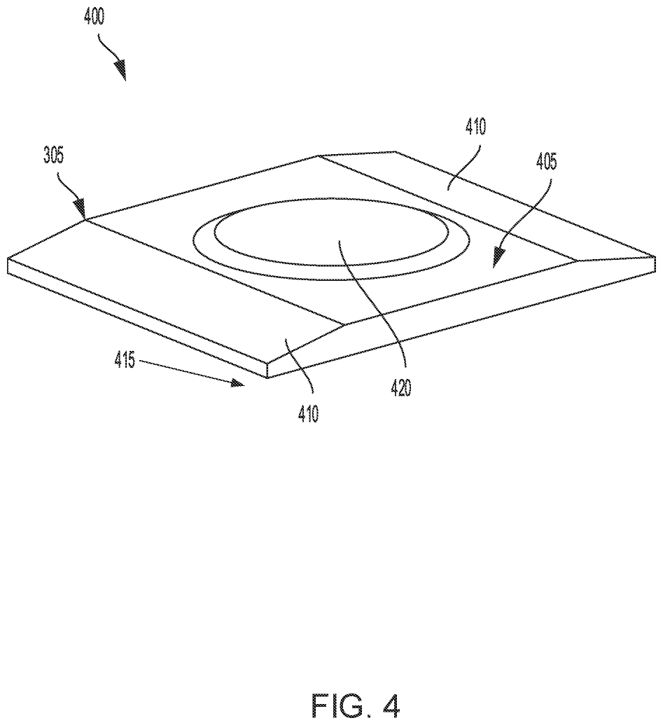

FIGS. 3 and 4 depict perspective views of systems 300, 400. FIG. 3 depicts a perspective view of a system 300 (e.g., alignment system, mobile alignment system, alignment measurement system, mobile system, etc.). The system 300 can be mobile. For example, the system 300 can be moved in a carrier (e.g., van, cargo van, truck, etc.). FIG. 4 depicts a perspective view of a plate system 400. The system 300 and the plate system 400 can each include at least one plate 305. The plate 305 can include at least one bottom portion 310 and at least one top portion 405. The plate 305 can include at least one side portion. The top portion 405 can receive a tire of the vehicle 105, as discussed herein. The plate 305 can include at least one ramp 410. The ramp 410 can be an integral part of the top portion 405 of the plate 305. For example, the ramp 410 can be built into the plate 305. The tire of the vehicle 105 can roll up the ramp 410 such that the tire contacts the top portion 405 of the plate 305 that is not the ramp 410.

The plate 305 can include at least one disk 420. For example, the disk 420 can be disposed on the top portion 405 of the plate 305. The disk can be an integral part of the plate 305. For example, the disk 420 can be built into the plate 305. The plate 305 can include the disk 420 to receive the tire of a vehicle. The plate 305 can include the disk 420 to engage the tire of a vehicle. For example, the tire of the vehicle can roll up the ramp 410 such that the tire contacts the disk 420 of the top portion 405 of the plate 305. The disk 420 can be movable within the plate 305. For example, the plate 305 can be a slip-and-turn plate. For example, the disk 420 can rotate within the plate 305. For example, the tire can engage with the disk 420 of the plate 305 and the disk 420 can rotate in response to a force provided by the tire. The plate 305 and the disk 420 can lift the vehicle 105 for purposes of aligning a drive train of the vehicle 105. For example, the tire of the vehicle 105 can roll up the ramp 410, the disk 420 can receive the tire of the vehicle 105, the plate 305 and the disk 420 can lift the tire of the vehicle 105 and thus the vehicle 105, and the disk 420 can rotate in response to a force provided by the tire as a result of the alignment of the drive train of the of vehicle 105.

The plate system 400 can include at least one surface 415. The surface 415 can be any platform that the vehicle 105 is located on. For example, the surface 415 can be in contact with the tire of the vehicle 105. The surface 415 can be any platform that the system 300 is located on. For example, the surface 415 can be in contact with the system 300. The ramp 410 of the plate 305 can be wedged between the surface 415 and the tire of the vehicle 105. For example, the surface 415 can contact the bottom portion 310 of the plate and the ramp 410 of the plate 305 can contact the tire of the vehicle. For example, the ramp 410 of the plate 305 can be wedged between the surface 415 and the tire of the vehicle 105 such that the tire of the vehicle 105 can roll up the ramp 410, the disk 420 can support (e.g., receive) the tire of the vehicle 105, the plate 305 and the disk 420 can lift the tire of the vehicle 105 and thus the vehicle 105, and the disk 420 can rotate in response to a force provided by the tire as a result of the alignment of the drive train of the of vehicle 105.

The system 300 can include at least one lift assembly 315. The lift assembly 315 can be mechanically, electrically, or electromechanically powered. For example, the lift assembly 315 can be electrically powered with a ball screw cap. The lift assembly 315 can move (e.g., raise, lift, lower, etc.) the plate 305 and the disk 420 of the plate 305 to move the tire of the vehicle 105. The lift assembly 315 and the components of the lift assembly 315 described herein can be made of a combination of acetal (also known as polyacetal or polyoxymethylene (POM)), aluminum, or a combination of acetal and aluminum. The lift assembly 315 and the components of the lift assembly 315 described herein can be made of another material or combination of materials. The lift assembly 315 can be transported to the vehicle 105 located in a remote area (e.g., removed from a location where the lift assembly 315 is stored).

The lift assembly 315 can include at least one member 320. The member 320 of the lift assembly 315 can include at least one portion 335, as discussed herein. The member 320 can couple with the plate 305. For example, the member 320 can couple with the top portion 405 or the bottom portion 310 of the plate 305. The member 320 can couple with the side portion of the plate 305. For example, the member 320 can clamp onto the ramp 410 of the plate 305 such that the member 320 is in contact with both the top portion 405 and the bottom portion 310 of the plate 305. The member 320 can be in contact with the side portion of the plate 305. The member 320 can couple with the top portion 405 of the plate 305. For example, the member 320 can magnetically couple with the top portion 405 such that the lift assembly 315 can move the plate 305. The member 320 can couple with the bottom portion 310 of the plate 305, as depicted in FIG. 3, among others. For example, the member 320 can be wedged between the plate 305 and the surface 415 such that it is in contact with the bottom portion 310 of the plate 305. The plate 305 can be transported to the vehicle 105 located in a remote area (e.g., removed from a location where the plate 305 is stored).

The member 320 can be wedged between the plate 305 and the surface 415 mechanically, electrically, or electromechanically. For example, the member 320 can be wedged between the plate 305 and the surface 415 via a jack and hammer. The plate 305 can define grooves to receive the member 320. For example, the bottom portion 310 of the plate 305 can define slots to receive with or otherwise engage the member 320 such that the member 320 can slide under the plate 305 with the tire of the vehicle 105 in contact with the top portion 405.

The lift assembly 315 can include at least one column 325. The column 325 can define at least one channel 330. The channel 330 can be a groove, a runner, a railing, and an indented open channel. The channel 330 does not have to be an indented open channel. For example, the channel can be an internal component of the column 325 such that it is not visible externally. The column 325 can define the channel 330. For example, the column 325 can define the channel 330 to receive the portion 335 of the member 320. The column 325 can define the channel 330 to receive the member 320. The portion 335 and the member 320 can be combined into a single part (e.g., unitary part). The portion 335 and the member 320 can be distinct parts. The channel 330 can receive the portion 335 of the member 320 and the portion 335 of the member 320 can slide or otherwise move along the channel 330. The portion 335 of the member 320 can couple the member 320 with the column 325. For example, the portion 335 can couple with the column 325 such that the member 320 and the column 325 are also coupled. The portion 335 of the member 320 can move along the channel 330. The lift assembly 315 can move the plate 305 and the disk 420 along the channel 330 and move the tire of the vehicle 105 via the member 320 and the coupling of the member 320 and the channel 330 by the portion 335 of the member 320. The lift assembly 315 can raise the plate 305 and the disk 420 along the channel 330 and raise the tire of the vehicle 105 via the member 320 and the coupling of the member 320 and the channel 330 by the portion 335 of the member 320.

The lift assembly 315 can include at least one support frame 340. The support frame 340 can border the member 320 of the lift assembly 315 and the plate 305. For example, the tire of the vehicle 105 can be in contact with the disk 420 of the plate 305, the member 320 can be in contact with the bottom portion 310 of the plate 305, and the support frame 340 can be positioned around the member 320 and the plate 305. With the support frame 340 positioned around the member 320 and the plate 305, the portion 335 of the member 320 can be coupled with the channel 330 of the column 325 to raise the member 320 and the plate 305. The column 325 can couple with the support frame 340. For example, the column 325 can removable or fixedly couple with the support frame 340. For example, the column 325 can be an integral part of the support frame 340. The column 325 does not have to be an integral part of the support frame 340. The column 325 can couple with the support frame 340 anywhere on the support frame 340. For example, the column 325 can couple with the support frame 340 at a corner of the support frame 340, as depicted in FIG. 3 among others. The column 325 does not have to couple with the support frame 340 at a corner of the support frame 340. For example, the column 325 can couple with the support frame 340 at a middle of the support frame 340

The support frame 340 can include at least one first component 345, at least one second component 350, and at least one third component 355. The support frame 340 does not need to include the first component 345, the second component 350, or the third component 355. For example, the support frame 340 can include only one of the first component 345, the second component 350, or the third component 355. The components 345, 350, 355 of the support frame 340 can provide stabilizing and structural support for the lift assembly 315 to move the plate 305 and the vehicle 105 along the column 325. For example, the components 345, 350, 355 can be positioned around (e.g., border) the member 320 and the plate 305 such that the weight of the vehicle 105 is distributed across the support frame 340. The components 345, 350, 355 can be straight or curved.

The first component 345 can couple with the second component 350. For example, the first component 345 can couple with the second component 350 at approximately (e.g., +/−10 degrees) a right angle. The first component 345 can couple with the third component 355. For example, the first component 345 can couple with the third component 355 at approximately (e.g., +/−10 degrees) a right angle. The components 345, 350, 355 can be the same length. The components 345, 350, 355 do not have to be the same length. For example, second component 350 and the third component 355 can be the same length and the first component 345 can be a different length. The first component 345 can be longer than the second component 350 and the third component 355.

The support frame 340 can include at least one wheel 360. The support frame 340 can support the wheel 360. The wheel 360 can contact the surface 415. For example, the wheel 360 can be located between the support frame 340 and the surface 415. The wheel 360 can be coupled with at least one of the components 345, 350, 355. For example, the wheel 360 can be located between at least one of the components 345, 350, 355 and the surface 415. The wheel 360 can assist in the movement of the support frame 340. For example, the tire of the vehicle 105 can be in contact with the disk 420 of the plate 305, the member 320 can be in contact with the bottom portion 310 of the plate 305, and the support frame 340 can be positioned around (e.g., border) the member 320 and the plate 305 via assistance from the wheel 360. For example, the support frame 340 can support the wheel 360 to contact the surface 415. It should be noted that the wheel 360 is provided for illustrative purposes and should be interpreted in a non-limiting manner. In another example, the wheel 360 may lock such to ensure the support frame 340 is stationary. The wheel 360 may lock such to ensure the support frame 340 is stationary to support the vehicle 105. The wheel 360 may lock to prevent the support frame 340 from moving. For example, the wheel 360 may lock to prevent the support frame 340 from moving when the support frame 340 is supporting the vehicle 105.

The system 300 and the plate system 400 can each be portable. For example, the apparatus can be stored at a first location and assembled at a second location of a vehicle. The system 300 and the plate system 400 can be moved from the first location to the second location. The apparatus can be stored in a service vehicle, e.g., a van. The apparatus can be assembled in the service vehicle and can lift the vehicle within the service vehicle. The system 300 can be compactable. For example, the column 325 and the components 345, 350, 355 of the support frame 340 can be coupled (e.g., coupled via hinge) with each other such that the support frame 340 can fold together or otherwise disassemble such that the lift assembly 315 can be stored approximately (e.g., +/−10%) flat. The system 300 can be stationary. For example, the system 300 can be mounted to the surface 415. For example, the column 325 and the components 345, 350, 355 of the support frame 340 can be fixedly coupled, e.g., welded, with each other such that the support frame 340 does not fold. The system 300 and the plate system 400 can be configured for remote transport capabilities. For example, the system 300 and the plate system 400 can be stored at the first location and transported to the second location of the vehicle. The system 300 and the plate system 400 can service a vehicle that may be broken down on the road at a location that is removed from the first location. The system 300 and the plate system 400 can be transportable. For example, the system 300 and the plate system 400 can be transported from the first location to the second location. The vehicle can be serviced by the system 300 and the plate system 400 at a remote location without having to transport the vehicle to a stationary service center.

The system 300 can include an alignment measurement system. For example, the system 300 can measure a vehicle rolling axis (e.g., roll axis). The vehicle rolling axis can include a line that intersects a front vehicle roll center and a back vehicle roll center. A roll center can include a point around which a vehicle chassis rolls.

The alignment measurement system can include an optical system (e.g., optical alignment measurement system, optical tracking system). The alignment measurement system can include a camera-based system (e.g., camera-based alignment measurement system, camera-based tracking system). The camera-based system can include one or more cameras. The alignment measurement system can include a set of targets for the cameras with centric clamping mounts. The clamping mounts can attach to the center hole or wheel hub. For example, the clamping mounts can attach to the center hole or wheel hub to connect to the rolling axis of the wheel. The alignment measurement system can eliminate a need to perform a rolling runout compensation. The alignment measurement system can allow the vehicle 105 to remain stationary during the alignment process (e.g., method). The alignment process can include alignment of the drive train and/or vehicle chassis.

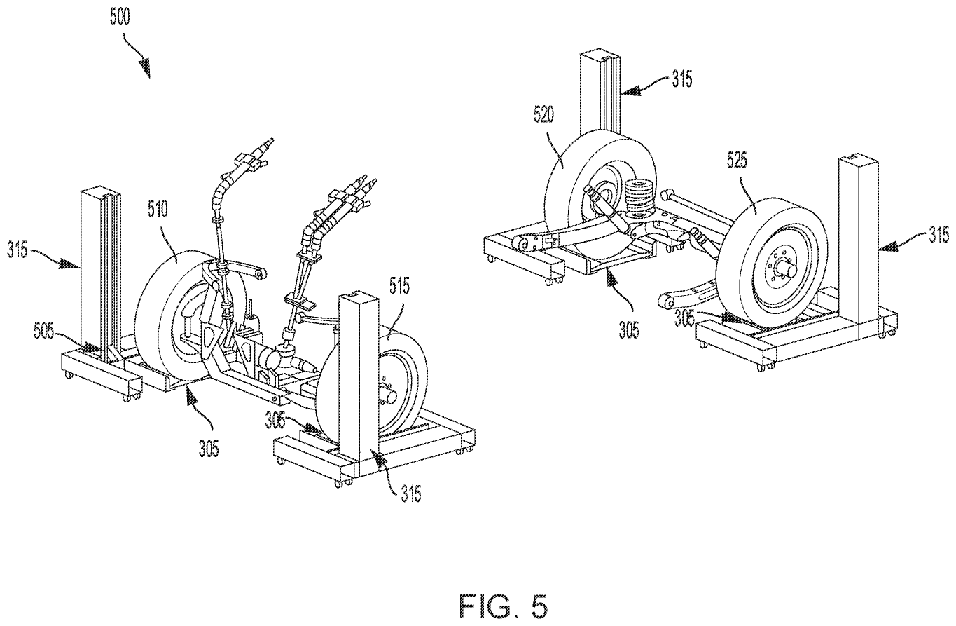

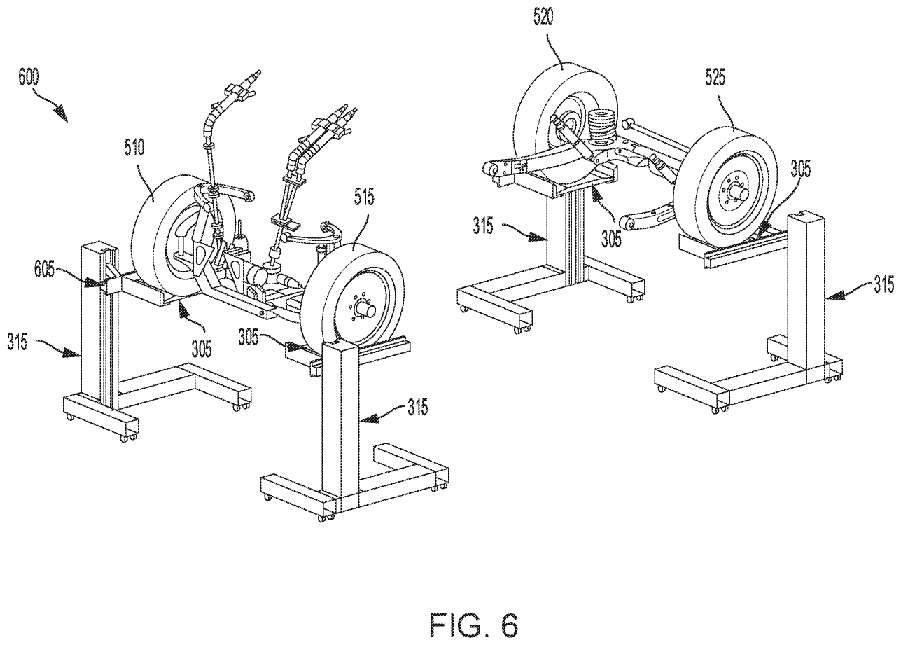

FIGS. 5 and 6 depict perspective views 500, 600 of the system 300. FIG. 5 depicts a perspective view 500 of the system 300 in a first position 505. FIG. 6 depicts a perspective view 600 of the system 300 in a second position 605. As depicted in FIGS. 5 and 6, a plurality of systems 300 and plate systems 400 can be provided such that a plurality of the components of the system 300 (e.g., the lift assembly 315) and a plurality of the components of the plate system 400 (e.g., the plate 305) is provided. For example, four systems 300 and four plate systems 400 can be provided to support (e.g., receive) a first tire 510, a second tire 515, a third tire 520, and a fourth tire 525. For example, the systems 300, 300 can support the weight of the tires 510, 515, 520, 525. The tires 510, 515, 520, 525 can each be the tire of the vehicle 105 as described herein. For example, the first tire 510 and the second tire 515 can be frontward tires of the vehicle 105 and the third tire 520 and fourth tire 525 can be rearward tires of the vehicle 105. For example, the first tire 510 can be associated with and below the front row passenger seat, the second tire 515 can be associated with the driver seat. It should be notate that while the figures illustrate wheels 360 underneath the lift assembly 315, this is proved for illustrative purposed and should be interpreted in a non-limiting manner. The wheels 360 may lock such to ensure the support frame 340 is stationary. The wheels 360 may lock such to ensure the support frame 340 is stationary to support the vehicle 105. The wheels 360 may lock to prevent the support frame 340 from moving. For example, the wheels 360 may lock to prevent the support frame 340 from moving when the support frame 340 is supporting the vehicle 105. In some embodiments, the lift assembly 315 may not include wheels 360.

With four top portions 405 of four plates 305, each of the four top portions 405 can receive one of the tires 510, 515, 520, 525 of the vehicle 105. The top portion 405 of the plate 305 can receive the first tire 510 of the vehicle 105. The top portion 405 of a second plate 305 can receive the second tire 515 of the vehicle 105. The second plate 305 can couple with a second lift assembly 315. For example, the second lift assembly 315 can move the second plate 305 and the second tire 515. The top portion 405 of a third plate 305 can receive the third tire 520 of the vehicle 105. The third plate 305 can couple with a third lift assembly 315. For example, the third lift assembly 315 can move the third plate 305 and the third tire 520. The top portion 405 of a fourth plate 305 can receive the fourth tire 525 of the vehicle 105. The fourth plate 305 can couple with a fourth lift assembly 315. For example, the fourth lift assembly 315 can move the fourth plate 305 and the fourth tire 525.

The system 300 can define at least one first position 505 and at least one second position 605. The first position 505 and the second position 605 can be defined along the column 325 such that the positions 505, 605 can be coupled with the column 325. The first position 505 can be greater than about 2 feet and less than about 3 feet above the second position 605 (e.g., in an operational orientation of the system). The lift assembly 315 can move the plate 305 and the first tire 510 of the vehicle 105 from the first position 505 to the second position 605. For example, the column 325 can define the channel 330 to receive the portion 335 of the member 320, the portion 335 of the member 320 can move along the channel 330 and move the member 320 and the plate 305 from the first position 505 coupled with the column 325 to the second position 605 coupled with the column 325. The lift assembly 315 can move the plate 305 and the disk 420 along the channel 330 and move the tire 510 of the vehicle 105 and the vehicle 105 from the first position 505 to the second position 605.

The plate 305, the second plate 305, the third plate 305, and the fourth plate 305 can lift the vehicle 105 from the first position 505 to the second position 605 with the plate 305, the second plate 305, the third plate 305, and the fourth plate 305 defining, within 10 degrees, a horizontal plane. For example, the plates 305 can lift the vehicle 105 from the first position 505 to the second position 605 such that the vehicle 105 is approximately (e.g., +/−10 degrees) level. The lift assembly 315 can move the tires 510, 515, 520, 525 of the vehicle 105 simultaneously. The lift assembly 315 can raise the tires 510, 515, 520, 525 of the vehicle 105 simultaneously. For example, the lift assembly 315 can be electronically powered and controlled so the tires 510, 515, 520, 525 of the vehicle 105 are lifted simultaneously.

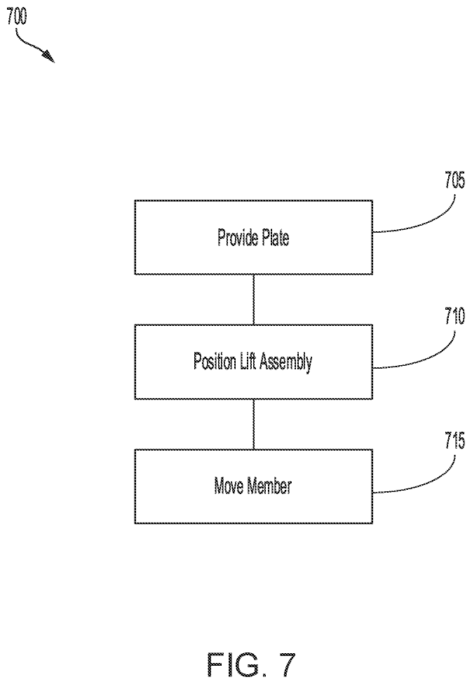

FIG. 7 depicts a flow diagram illustrating a method 700. Method 700 can include the method of assembling the system 300 and the plate system 400. Method 700 can include providing the plate 305 (Act 705). The plate 305 can include the bottom portion 310 and the top portion 405. The top portion 405 can receive the first tire 510 of the vehicle 105. Method 700 can include providing the second plate 305 to couple with the second lift assembly 315. The second plate 305 can receive the second tire 515 of the vehicle 105. Method 700 can include providing the third plate 305 to couple with the third lift assembly 315. The third plate 305 can receive the third tire 520 of the vehicle 105. Method 700 can include providing the fourth plate 305 to couple with the fourth lift assembly 315. The fourth plate 305 can receive the fourth tire 525 of the vehicle 105.

The plate 305 can include the ramp 410. Method 700 can include wedging the ramp 410 of the plate 305 between the surface 415 and the first tire 510 of the vehicle 105. The plate 305 can include the disk 420. Method 700 can include providing the disk 420 of the plate 305 to engage the first tire 510 of the vehicle 105. The disk 420 can be disposed on the top portion 405 of the plate 305. The plate 305 can include the disk 420 to receive the first tire 510 of the vehicle 105. The plate 305 can include the disk 420 to engage the first tire 510 of the vehicle 105. The disk 420 can be movable within the plate 305. For example, the disk 420 can rotate within the plate 305. The plate 305 and the disk 420 can lift the vehicle 105 for purposes of aligning a drive train of the vehicle 105. For example, the first tire 510 of the vehicle 105 can roll up the ramp 410, the disk 420 can receive the first tire 510 of the vehicle 105, the plate 305 and the disk 420 can lift the first tire 510 of the vehicle 105 and thus the vehicle 105, and the disk 420 can rotate in response to a force provided by the first tire 510 as a result of the alignment of the drive train of the of vehicle 105.

Method 700 can include positioning the lift assembly 315 (Act 710). Method 700 can include positioning the lift assembly 315 adjacent to the plate 305. The lift assembly 315 can include the member 320. The member 320 can couple with the plate 305. For example, the member 320 can couple with the top portion 405 and the bottom portion 310 of the plate 305. For example, the member 320 can be wedged between the plate 305 and the surface 415 such that it is in contact with the bottom portion 310 of the plate 305. The lift assembly 315 can include the column 325.

Method 700 can include moving the member 320 (Act 715). Method 700 can include moving the member 320 along the channel 330 defined in the column 325. The column 325 can define the channel 330 to receive the portion 335 of the member 320. The portion 335 of the member 320 can move along the channel 330. For example, the portion 335 of the member 320 can move along the channel 330 and raise the member 320 and the plate 305 from the first position 505 coupled with the column 325 to the second position 605 coupled with the column 325.

Method 700 can include assembling the support frame 340. Method 700 can include assembling the support frame 340 to border the member 320 of the lift assembly 315 and the plate 305. The support frame 340 can include the components 345, 350, 355. The first component 345 can couple with the second component 350. For example, the first component 345 can couple with the second component 350 at approximately (e.g., +/−10 degrees) a right angle. The first component 345 can couple with the third component 355. For example, the first component 345 can couple with the third component 355 at approximately (e.g., +/−10 degrees) a right angle.

Method 700 can include moving (e.g., raising, lifting, lowering, etc.), via the lift assembly 315, the plate 305 and the disk 420 along the channel 330. Method 700 can include moving, via the lift assembly 315, the first tire 510 of the vehicle 105 and the vehicle 105 from the first position 505 to the second position 605. Method 700 can include moving, via the plate 305, the second plate 305, the third plate 305, and the fourth plate 305 the vehicle 105 from the first position 505 to the second position 605 with the plate 305, the second plate 305, the third plate 305, and the fourth plate 305 defining, within 10 degrees, the horizontal plane. Method 700 can include defining within 10 degrees the horizontal plane. Method 700 can include aligning the drive train of the vehicle 105. For example, the method 700 can include aligning the drive train of the vehicle 105 after moving, via the lift assembly 315, the plate 305 and the vehicle 105 along the channel 330.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “about,” “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A mobile system, comprising:
a plate; and
a lift assembly, comprising:
a member to couple with the plate; and
a column that defines a channel to receive the member, the member configured to move along the channel.

2. The mobile system of claim 1, wherein the plate and lift assembly are configured to be transported to a vehicle in a remote area, comprising:
the plate including a top portion to support a first tire of the vehicle;
a second plate to couple with a second lift assembly, the second plate to support a second tire of the vehicle;
a third plate to couple with a third lift assembly, the third plate to support a third tire of the vehicle;
a fourth plate to couple with a fourth lift assembly, the fourth plate to support a fourth tire of the vehicle; and
the plate, the second plate, the third plate, and the fourth plate configured to lift the vehicle from a first position to a second position with the plate, the second plate, the third plate, and the fourth plate defining, within 10 degrees, a horizontal plane.

3. The mobile system of claim 1, comprising:
the plate including a ramp to wedge between a surface and a tire of a vehicle;
the plate including a disk to engage the tire of the vehicle, the disk moveable within the plate;
the lift assembly including a support frame to border the member of the lift assembly and the plate; and
the lift assembly configured to move the plate and the disk along the channel and move the tire of the vehicle and the vehicle from a first position to a second position.

4. The mobile system of claim 1, comprising:
the lift assembly including a support frame configured to border the member of the lift assembly and the plate;
the support frame having a first component coupled with a second component at a right angle, within 10 degrees, and the first component coupled with a third component at a right angle, within 10 degrees; and
the column coupled with the support frame at a corner of the support frame.

5. The mobile system of claim 1, comprising:
the lift assembly including a support frame configured to border the member of the lift assembly and the plate;
the support frame configured to support a wheel to contact a surface; and
the column coupled with the support frame at a corner of the support frame.

6. The mobile system of claim 1, comprising:
the lift assembly including a support frame configured to border the member of the lift assembly and the plate; and
the support frame having a first component coupled with a second component and the first component coupled with a third component, wherein the first component is longer than the second component and the third component.

7. The mobile system of claim 1, comprising:
the plate including a disk to support a tire of a vehicle, the disk moveable within the plate; and
the plate and the disk configured to lift the vehicle for purposes of aligning a drive train of the vehicle.

8. The mobile system of claim 1, comprising:
the plate including a top portion to receive a first tire of a vehicle;
a second plate to receive a second tire of the vehicle;
a third plate to receive a third tire of the vehicle; and
a fourth plate to receive a fourth tire of the vehicle.

9. The mobile system of claim 1, comprising:
the plate including a ramp to be wedged between a surface and a tire of a vehicle; and
the plate to receive the tire of the vehicle.

10. The mobile system of claim 1, wherein:
the member is configured to move from a first position coupled with the column to a second position coupled with the column; and
the first position is greater than 2 feet and less than 3 feet above the second position in an operational orientation of the system.

11. The mobile system of claim 1, wherein the member is configured to move from a first position coupled with the column to a second position coupled with the column.

12. The mobile system of claim 1, wherein the system is portable.

13. A method, comprising:
providing a plate; and
positioning a lift assembly adjacent to the plate, the lift assembly comprising a member to couple with the plate; and
moving the member along a channel defined in a column.

14. The method of claim 13, wherein the plate includes a top portion to support a first tire of a vehicle, the method comprising:
providing a second plate to couple with a second lift assembly, the second plate to support a second tire of the vehicle;
providing a third plate to couple with a third lift assembly, the third plate to support a third tire of the vehicle;
providing a fourth plate to couple with a fourth lift assembly, the fourth plate to support a fourth tire of the vehicle; and
moving, via the plate, the second plate, the third plate, and the fourth plate the vehicle from a first position to a second position with the plate, the second plate, the third plate, and the fourth plate defining, within 10 degrees, a horizontal plane.

15. The method of claim 13, comprising:
wedging a ramp of the plate between a surface and a tire of a vehicle;
providing a disk of the plate to engage the tire of the vehicle, the disk moveable within the plate;
assembling a support frame of the lift assembly to border the member of the lift assembly and the plate;
moving, via the lift assembly, the plate and the disk along the channel; and
moving, via the lift assembly, the tire of the vehicle and the vehicle from a first position to a second position.

16. The method of claim 13, comprising:
providing a support frame of the lift assembly configured to border the member of the lift assembly and the plate, the support frame comprising:
a first component to couple with a second component at a right angle, within 10 degrees, and the first component to couple with a third component at a right angle, within 10 degrees; and
coupling the column with the support frame at a corner of the support frame.

17. The method of claim 13, comprising:
providing a support frame of the lift assembly configured to border the member of the lift assembly and the plate and configured to support a wheel to contact a surface; and
coupling the column with the support frame at a corner of the support frame.

18. The method of claim 13, comprising:
providing a support frame of the lift assembly configured to border the member of the lift assembly and the plate, the support frame comprising:
a first component to couple with a second component and the first component to couple with a third component, wherein the first component is longer than the second component and the third component.

19. The method of claim 13, comprising:
wedging a ramp of the plate between a surface and a tire of a vehicle, wherein the plate to receive the tire of the vehicle; and
lifting the plate and the tire of the vehicle greater than 2 feet and less than 3 feet.

20. The method of claim 13, comprising:
providing a disk of the plate configured to receive a tire of a vehicle, wherein the disk is moveable within the plate;
lifting the disk and the vehicle greater than 2 feet and less than 3 feet; and
aligning a drive train of the vehicle.
